(19) United States
(12) Patent Application Publication
(10) Pub. No.: US 2025/0145840 A1
(43) Pub. Date: May 8, 2025

(54) DISPERSANT COMPOSITION FOR USE IN MANUFACTURING BATTERIES

(71) Applicant: BYK-Chemie GMBH, Wesel (DE)

(72) Inventors: Yuli Wang, Shanghai (CN); Yu Sugioka, Osaka (JP); Megumu Takai, Hyogo (JP); Ina Van Kamp, Dinslaken (DE); David Samol, Gelsenkirchen (DE); Robin Von Hagen, Dusseldorf (DE)

(21) Appl. No.: 18/836,427

(22) PCT Filed: Mar. 20, 2023
(86) PCT No.: PCT/EP2023/057035

§ 371 Date: Aug. 7, 2024

(30) Foreign Application Priority Data
Mar. 21, 2022 (WO) PCT/CN2022/082009
Apr. 20, 2022 (EP) 22168947.4

(51) Int. Cl. C09D 5/24; C09D 7/61; C09D 7/63; C09D 7/65; C09D 127/12; H01M 4/62

(52) U.S. Cl. CPC C09D 5/24; C09D 7/61; C09D 7/63; C09D 7/65; C09D 127/12; H01M 4/622; H01M 4/625

(57) ABSTRACT

The invention relates to dispersant composition comprising a) 30 to 80% by weight of at least one first polymer b) 10 to 60% by weight of at least one amine having a molecular weight of at most 250 g/mol, and c) 5 to 20% by weight of at least one second polymer, which is different from the first polymer, wherein the % by weight are calculated on the total weight of a), b), and c).

The invention relates to a dispersant composition comprising polymers and an amine, the use of the composition as a dispersing agent for an electrically conductive carbon-based material and for reducing the viscosity of a composition for preparing an electrode for a rechargeable battery, to a composition for preparing an electrode for a rechargeable battery, to a process of preparing a dispersion of an electrically conductive carbon-based material, and to a process of preparing a rechargeable electrical battery electrode.

International patent application WO 2019/236313 A1 describes compositions that can be used in producing battery electrodes. In some examples dispersions of conductive carbon are disclosed, wherein a cellulose derivative, a dispersant additive, and a low amount of a low molecular weight amine are present. It has been found that the viscosity of these compositions is high and that the viscosity of the compositions tends to increase upon storage. It is desirable to provide compositions having a lower viscosity, and in particular to provide compositions having a limited increase of viscosity upon storage.

European patent application EP 3786110 A1 relates to a dispersion comprising carbon nanotubes, polyvinylpyrrolidone, N-methyl-2-pyrrolidone, and an amine-based compound. The dispersions described in this document are not fully satisfactory with respect with respect to stability towards sedimentation and volume resistivity of the resulting electrode materials.

International patent application WO2020/173821 A1 relates to a composition comprising a polymer comprising polymerized units of a N-vinyl lactam and a comb polymer, and to the use of the composition as a dispersing agent for a carbon-based material.

The present invention seeks to provide compositions suitable for preparing an electrode for a rechargeable battery having desirable low viscosity, a good stability of the dispersion, and further providing desirable electrochemical properties of the rechargeable battery, in particular a low volume resistivity of resulting electrode materials.

The invention provides a dispersant composition comprising
a) 30 to 80% by weight of at least one first polymer
b) 10 to 60% by weight of at least one amine having a molecular weight of at most 250 g/mol, and
c) 5 to 20% by weight of at least one second polymer, which is different from the first polymer, wherein the % by weight are calculated on the total weight of a), b), and c).

The dispersant composition according to the invention is very suitable for use in compositions for preparing an electrode for a rechargeable battery. The compositions for preparing an electrode have a desirable low viscosity, a good stability of the dispersion, and further provide desirable electrochemical properties of the rechargeable battery, such as a low volume resistivity of resulting electrode materials.

In preferred embodiments, the dispersant composition comprises
a) 40 to 75% by weight of the at least one first polymer,
b) 15 to 55% by weight of the of at least one amine having a molecular weight of at most 250 g/mol, and
c) 7 to 15% by weight of the at least one second polymer, which is different from the first polymer.

When the amount of components in the dispersant composition is within these preferred ranges, the above-mentioned advantages are achieved to a greater extent.

The dispersant composition comprises at least one first polymer. The at least one polymer is not particularly restricted in view of the repeating units. Homopolymers are suitable, as well as copolymers comprising two or more different types of repeating units. In preferred embodiments, the repeating units comprise carbon atoms, as well as hetero atoms comprising oxygen or nitrogen or oxygen and nitrogen.

Generally, the first polymer is selected from linear polymers having a linear polymer chain without polymeric side chains or polymeric branches.

In preferred embodiment, the at least one first polymer comprises polymerized units of a N-vinyl lactam. Polymerized units refer to N-vinyl lactams that have undergone polymerization of the ethylenically unsaturated vinyl group. Examples of suitable N-vinyl lactams may have 4-, 5-, 6-, or 7-membered rings, also referred to as beta, gamma, delta or epsilon lactams.

Preferred examples include N-vinyl pyrrolidone and N-vinyl caprolactam.

In one embodiment, the first polymer is a copolymer of an N-vinyl lactam and other monomers having ethylenically unsaturated polymerizable groups. Examples of other monomers include esters of acrylic and methacrylic acid, vinyl aromatic compounds, and vinyl esters. In preferred embodiments, the first polymer consists of at least 50%, more preferably at least 80% by weight of polymerized units of N-vinyl lactams.

In one embodiment, the first polymer comprises polymerized units of one type of N-vinyl lactam. In other embodiments, the first polymer comprises polymerized units of two or more different types of N-vinyl lactams. It is preferred that the first polymer comprises or consists of polymerized units of N-vinylpyrrolidone.

In other embodiments, the at least one first polymer comprises a vinyl polymer, such as a polyvinyl butyral resin, polyvinyl caprolactam, polyvinyl pyrrolidone copolymers such as polyvinyl pyrrolidone-co-vinyl acetate, butylated polyvinyl pyrrolidone such as Ganex™ P-904LC polymer, polyvinylpyrrolidone-co-dimethylaminopropylmethacrylamide, polyvinylpyrrolidone-co-dimethylaminoethylmethacrylate, maleic imide copolymers such as isobutylene-ethylmaleimide-hydroxyethylmaleimide copolymer (Aquflex™ FX-64 product), poly(acrylonitrile-co-butadiene), or dicarboxy terminated poly(acrylonitrile-co-butadiene).

In further embodiments, the at least one polymer comprises a polysaccharide or a modified polysaccharide. In some embodiments, the modified polysaccharide comprises at least one of an alkylated polysaccharide, a hydroxy-alkylated polysaccharide, and an acetylated polysaccharide.

The expression alkylated polysaccharide or hydroxy-alkylated polysaccharide is herein understood as a compound in which a hydroxyalkyl or alkyl group, preferably hydroxyalkyl group is linked to a polysaccharide moiety. The hydroxyalkyl or alkyl group, preferably hydroxyalkyl group may be linked to the polysaccharide moiety naturally or artificially, such as by means of chemical or enzymatic synthesis.

The polysaccharide moiety may comprise any polysaccharide comprising at least 5, preferably 10 monosaccharide monomers linked to each other by glycosidic bonds, such as for example linked to each other by alpha and/or beta glycosidic bonds. The polysaccharide moiety of may comprise a cellulose, alkyl cellulose, such as a C1-4 alkylcellulose, preferably a methylcellulose, ethylcellulose or ethyl methyl cellulose, arabinoxylan, chitin or pectin moiety.

The hydroxyalkyl group of the hydroxyalkylated polysaccharide may be a linear or branched C1-10 hydroxyalkyl, preferably a linear or branched C2-5 hydroxyalkyl group. The hydroxy group of the hydroxyalkyl group of the hydroxyalkylated polysaccharide may be a primary or secondary hydroxy group. The hydroxyalkyl group may linked to the polysaccharide moiety by an ester bond, an ether bond, an amide bond or an amino bond, preferably an ether bond. The hydroxyalkylated polysaccharide has suitably has a degree of hydroxyalkylation of at least 80 mol-%, based on the percentage of hydroxyalkylation of potential free linking groups of the respective polysaccharide. Hydroxyalklyation generally occurs via reaction of free hydroxyl groups of the polysaccharide with an alkylene oxide, preferably ethylene oxide or propylene oxide. When the polysaccharides are hydroxyalkylated with propylene oxide, the hydroxylated polysaccharide generally comprises 20 to 80 weight-%, preferably 22 to 65 weight-%, of reacted propylene oxide, calculated on the weight of the hydroxylated polysaccharide.

The alkyl group of the alkylated polysaccharide may be a linear or branched C1-10 alkyl, preferably a linear or branched C2-5 alkyl group. The alkyl group may be linked to the polysaccharide moiety by an ester bond, an ether bond, an amide bond or an amino bond, preferably an ether bond. The alkylated polysaccharide generally has a degree of alkylation of 30 to 100%, based on the percentage of alkylation of potential free linking groups of the respective polysaccharide.

The alkylated polysaccharide preferably comprises a cellulose or methyl cellulose moiety. The terms cellulose and methyl cellulose are well known to a person skilled in the art. The alkylated polysaccharide may be an alkylated cellulose or methyl cellulose.

The alkylated or hydroxy-alkylated polysaccharide preferably comprises at least 1, preferably 2 free alcohol groups per 5 monosaccharide monomer units. The alkylated or hydroxy-alkylated polysaccharide preferably comprises at least 2, preferably at least 3, more preferably at least 4 free alcohol groups per 10 monosaccharide monomer units.

The alkalyted or hydroxy alyklated polysaccharide preferably is selected from the group consisting of hydroxypropyl cellulose, hydroxyethyl cellulose, hydroxypropyl methylcellulose, ethyl hydroxyethyl cellulose, methyl cellulose, ethyl cellulose, ethyl methyl cellulose, and any mixtures thereof. The acetylated polysaccharide may be cellulose acetate.

In preferred embodiments, the at least one first polymer is selected from polyvinylpyrrolidone, modified cellulose, or mixtures thereof. It is particularly preferred that the modified cellulose comprises hydroxymethylpropyl cellulose.

The molecular weight of the at least one first polymer is not particularly limited. In some embodiments, the weight average molecular weight of the first polymer is in the range of 2000 to 500000 g/mol, preferably in the range of 5000 to 100000 g/mol. It is particularly preferred that the first polymer has a weight average molecular weight in the range of 15000 to 80000 g/mol.

The weight average molecular weight can suitably be determined by gel permeation chromatography (GPC), using poly methyl methacrylate as calibration standard and N,N-dimethylacetamide as eluent.

As mentioned above, the dispersant composition of the invention comprises at least one amine having molecular weight of at most 250 g/mol. The amine may be a primary amine, a secondary amine, or a tertiary amine, and does not include ammonia or a quaternary ammonium compound. Usable amines include, other than monoamines, amine-based compounds having a plurality of amino groups in the molecule, such as diamines, triamines, and tetramines. In addition to the above-mentioned compounds, nitrogen-containing alicyclic heterocyclic compounds can also be used. Therefore, the amino group herein is a primary, secondary, or tertiary functional group.

The amine used in the composition of the invention is preferably at least one amine-based compound selected from the group consisting of an aliphatic primary amine, an aliphatic secondary amine, an aliphatic tertiary amine, and an alkanolamine. The amine is more preferably at least one amine-based compound having only one amino group, which is selected from the group consisting of an aliphatic primary amine, an aliphatic secondary amine, an aliphatic tertiary amine, and an alkanolamine.

The amine can be used alone or in combination of two or more amines, regardless of whether it is a commercially available product or a synthetic product.

Specific examples of suitable amines include, but are not limited to, aliphatic primary amines such as ethylamine, octylamine, stearylamine, aliphatic secondary amines such as diethylamine, dibutylamine, aliphatic tertiary amines such as triethylamine, dimethyloctylamine, dimethyldecylamine, dimethyllaurylamine, dimethylstearylamine, and alkanolamines such as dimethylaminoethanol, monoethanolamine, diethanolamine, methyldiethanolamine, and triethanolamine, and nitrogen-containing alicyclic heterocyclic compounds such as hexamethylenetetramine, morpholine, and piperidine.

The amine preferably has a number of carbon atoms of 2 or more and 20 or less, more preferably 2 or more and 15 or less, still more preferably 2 or more and 10 or less.

The number of amino groups contained in the amine is preferably 1 or more and 4 or less, more preferably 1 or more and 2 or less, and particularly preferably 1 or 2.

In a further preferred embodiment, the at least one amine having a molecular weight of at most 250 g/mol has one amine group and one hydroxyl group.

It has been found that the presence of the at least one amine having molecular weight of at most 250 g/mol in the specified amount is essential for achieving the desired properties of the dispersant composition, such as providing compositions for preparing an electrode for a rechargeable battery having a desirable low and stable viscosity, a good stability of the dispersion.

The dispersant composition of the invention further comprises at least one second polymer, which is different from the first polymer.

In some embodiments, the at least one second polymer is a fatty acid modified polyether. The polyether is preferably a polyalkylene oxide based on polyethylene oxide, polypropylene oxide, and mixtures thereof. In typical embodiments, the polyether has 4 to 100 ether groups, preferably 5 to 50 ether groups. The fatty acid generally is a fatty acid having 12 to 24 carbon atoms. The fatty acid can be saturated or unsaturated. Unsaturated fatty acids are preferred. Typically, the fatty acid is linked to the polyether via a linking moiety comprising or consisting of an ester group. In a preferred embodiment, the fatty acid modified polyether comprises a terminal carboxylic acid group, which is optionally neutralized by an amine. The neutralizing amine preferably has a molecular weight higher than 250 g/mol. Suitable neutralizing amines are amino amides based on fatty acids and polyamines.

In preferred embodiments, the at least one second polymer is selected from comb polymers, branched polymers, hyperbranched polymers, and mixtures thereof.

A comb polymer is a copolymer having at least two polymeric side chains linked to the polymer backbone.

In some embodiments, the comb polymer in the composition of the invention is a comb polymer having a polymer backbone based on a vinyl aromatic compound and ethylenically unsaturated polymerizable carboxylic anhydride, and having at least two polyalkylene oxide side chains.

The polymer backbone of the comb polymer generally is essentially linear, i.e. it is prepared by polymerization of ethylenically unsaturated polymerizable monomers having one ethylenically unsaturated polymerizable bond. If so desired, minor amounts of branching may be present in the polymer backbone, for example by including monomers having more than one ethylenically unsaturated polymerizable bond.

The polymer backbone of comb polymer suitably comprises polymerized units of a vinyl aromatic compound. Examples of suitable vinyl aromatic compounds include styrene, vinyl toluene, vinyl xylene, vinyl ethylbenzene, and mixtures thereof. The polymer backbone of comb polymer further suitably comprises polymerized units of an ethylenically unsaturated polymerizable carboxylic anhydride, or of an ethylenically unsaturated polymerizable dicarboxylic acid. Examples of suitable monomers include maleic anhydride, itaconic anhydride, citraconic anhydride, fumaric acid, esters of the aforementioned compounds, and mixtures thereof. The polymer backbone of the comb polymer can suitably be prepared by copolymerization of the above described two types of monomers. If so desired, other monomers may be included in the polymer backbone, for example acrylic or methacrylic acid as well as esters thereof. In a preferred embodiment, the polymer backbone of the comb polymer is a copolymer of styrene and maleic anhydride.

In preferred embodiments, the comb polymer has at least two polyalkylene oxide side chains linked to the polymer backbone. The comb copolymer generally has two to 100, preferably 2 to 50, more preferably 3 to 25, most preferably 4 to 12 polyalkylene oxide side chains. Generally, the polyalkylene oxide side chains are polyethers based on polymerized units of epoxides or oxetanes. Typically, the polyalkylene oxide side chains are based on polymerized units of ethylene oxide, propylene oxide, butylene oxide, and mixtures thereof. In the case of mixtures of alkylene oxides, these may be present in the polyalkylene oxide chain the form of two or more blocks or in random order. Polyalkylene oxide side chains based on ethylene oxide, propylene oxide, and in particular mixtures thereof, are preferred.

The weight average molecular weight of the polyalkylene oxide side chains generally is in the range of 200 to 6000 g/mol, preferably 300 to 4000 g/mol. In some embodiments, the polyalkylene oxide side chains have ether end groups, for example alkyl ether end groups, such as ethyl or methyl ether end groups.

The polyalkylene oxide side chains can be linked to the polymer backbone by reaction of amine or alcohol terminated mono-functional polyoxyalkylene oxides with carboxylic anhydride groups of the polymer backbone. Reaction of a primary amine group with a carboxylic anhydride group can result in an amide link or in an imide link. It is preferred that the polyoxyalkylene oxide side chains of comb copolymer b) are linked to the polymer backbone via an amide group or an imide group, for example by reaction of a copolymer of styrene and maleic anhydride with a polyether monoamine. Suitable polyether amines are available under the trade designation Jeffamine® M from Huntsman. In a further preferred embodiment, the polyalkylene oxide side chains are linked to the polymer backbone via an ester link. This can be achieved by reacting carboxylic anhydride groups of the polymer backbone with hydroxyl terminated polyalkylene oxide mono-ethers.

In preferred embodiments, the comb copolymer comprises further functional groups comprising at least one of hydroxyl, carboxylic acid, salt of carboxylic acid, tertiary amine, salt of tertiary amine, and quaternary ammonium.

Hydroxyl groups may be included by reacting carboxylic anhydride groups of the polymer backbone with alkanolamines, such as ethanol amine.

Carboxylic acid groups may be included by ring opening reactions of carboxylic anhydride groups of the polymer backbone with alcohols or amines. The carboxylic acid groups may be neutralized by a base to form salts of carboxylic acids.

The comb copolymer b) suitably has an acid value in the range of 0 to 300 mg KOH/g. In preferred embodiments, the acid value of comb copolymer is in the range of 0 to 150 mg KOH/g, more preferred 0 to 100 mg KOH/g, or 0 to 70 mg KOH/g.

Tertiary amine groups may be introduced by reacting carboxylic anhydride groups of the polymer backbone with diamines having a tertiary amine group and a primary or secondary amine group, such as 3-dimethyl amino propylamine. The tertiary amines may be neutralized with an acid to form a salt thereof. Alternatively, the tertiary amines may be quaternized with a quaternization agent to form a quaternary ammonium group. Examples of suitable quaternization agents include alkyl halides or benzyl halides, as well as epoxides in combination with carboxylic acids. Comb copolymer comprising at least one of tertiary amine, salt of tertiary amine, and quaternary ammonium are preferred.

The comb copolymer suitably has an amine value in the range of 0 to 300 mg KOH/g. In preferred embodiments, the amine value of comb copolymer is in the range of 0 to 150 mg KOH/g, more preferred 0 to 100 mg KOH/g, or 0 to 70 mg KOH/g.

The weight average molecular weight of comb copolymer suitably is in the range of 4000 to 100000 g/mol, preferably in the range of 6000 to 60000 g/mol. The weight average molecular weight can be determined as described above for the at least one first polymer.

Examples of further suitable comb polymers and the preparation thereof are described in detail in European patent application EP 2125910 A.

In preferred embodiments, the at least one second polymer comprises a comb polymer having a polymer backbone comprising polymerized units of styrene and maleic anhydride, and lateral side chains comprising ether groups.

It is further preferred, that the at least one second polymer further comprises neutralized carboxylic acid groups.

In a further embodiment, the at least one second polymer is a polymer having a linear or essentially linear polymer backbone and having pendant amide groups. Generally, the polymer backbone consists of polymerized units of mono-ethylenically unsaturated monomers. Examples of suitable monomers include acrylic acid alkyl esters, itaconic acid esters, maleic acid esters, (meth)acrylic acid esters, (meth)acrylic acid, styrene, alkyl vinyl ethers, and vinyl esters, such as vinyl acetate. The pendant amide groups are generally present as alkyl amides, aryl amides, arylalkyl amides, or aminoalkyl amides. In some embodiments, the pendant amide groups are generated by amidation of ester groups of the polymer with suitable amines, for example with primary monoamines or with primary amines further having a tertiary amine group. Examples of suitable polymers having a linear or essentially linear polymer backbone and having pendant amide groups are described in U.S. Pat. No. 6,596,816 B1.

The at least one second polymer may also be a branched or hyperbranched polymer. Mixtures of such polymers are suitable, too.

In preferred embodiments, the branched or hyperbranched polymers are based on a polyamine core having a plurality of amine groups. It is particularly preferred that the polyamine core is a polyalkylene imine, such as a polyethylene imine. The polyamine core is suitably linked to a plurality of polymeric branches. The polymeric branches suitably comprise polyether units or polyester units, or combinations thereof. The polymeric branches are linked to the polyamine core by linking groups. Examples of suitable linking groups include urea groups, urethane groups, ether groups, and amide groups.

In one embodiment, such branched polymers are obtainable by reacting.
a) one or more polyisocyanates containing uretdione groups with.
b) one or more compounds of the formula (I)

Y—(XH)ₙ (I)

wherein
XH is a group that is reactive towards isocyanates and
Y is a monomeric or polymeric group that is not reactive towards isocyanates and which comprises one or more aliphatic, cycloaliphatic, araliphatic and/or aromatic groups, Y possessing a number-average molar mass of less than 20 000 g/mol, and n is 1, 2 or 3, and for at least 50 mol % of the compounds of the formula (I) it is the case that n=1, with the proviso that substantially all free isocyanate groups of component a) are reacted with the compounds of the formula (I) to give an intermediate which contains uretdione groups,
and subsequently the uretdione groups are reacted with.
c) one or more compounds of the general formula (II)

Z—NHR (II)
in which R is hydrogen or a straight-chain or branched alkyl group having 1 to 4 carbon atoms and Z is an aliphatic, cycloaliphatic and/or aromatic basic radical
and, if desired, after this reaction, reacting any reactive amino groups still present in the reaction product with compounds that are reactive towards amino groups.

Examples of such branched polymers are described in more detail in U.S. Pat. No. 8,362,300 B2.

In some embodiments, the branched polymers are based on a polyamine core having polymeric branches of polyester segments, and wherein the branched polymer is further modified by reaction with an epoxy-functional compound. Preferably, the epoxy-functional compound comprises one epoxide group. The reaction with the epoxy-functional compound can occur prior, during or after attachment of the polymeric branches of polyester segments to the polyamine core.

Examples of such branched polymers are described in more detail in U.S. Pat. No. 9,574,121.

Polymeric branches of polyester segments usually contain at least 3, preferably 4 to 50 ester groups. In some embodiments, the polyester segments additionally comprise ether groups.

In preferred embodiments, the polyester segments are linear, caprolactone polyesters, which each preferably have a weight-average molecular weight of 500 to 10000, preferably of 800 to 8000 g/mol.

Particularly suitable polyester segments are those that can be obtained by polycondensation of one or more, optionally alkyl-substituted, hydroxycarboxylic acids such as ricinoleic acid or 12-hydroxystearic acid and/or ring-opening polymerization of the corresponding lactones, such as propiolactone, valerolactone, and caprolactone. Particularly preferred are polyester segments on the basis of E-caprolactone, optionally in combination with o-valerolactone.

Other suitable polyester segments are produced by reacting dicarboxylic acids and their esterifiable derivatives such as anhydrides, acid chlorides or dialkyl esters, such as dimethyl esters or diethyl esters, by reacting with diols and monofunctional carboxylic acids. If necessary, the formation of dihydroxypolyesters can be suppressed by the use of corresponding stoichiometric quantities of monofunctional carboxylic acids. Examples of dicarboxylic acids that can be used in this way are succinic acid, maleic acid, fumaric acid, glutaric acid, adipic acid, sebacic acid, pimelic acid, phthalic acid or dimerized fatty acids and their isomers as well as their hydrogenation products. Examples of diols that can be used in this way are: ethylene glycol, 1,2-propanediol, 1,3-propanediol, 1,4-butanediol, 1,6-hexanediol, neopentyl glycol, cis-1,2-cyclohexanedimethanol, trans-1,2-cyclohexane-dimethanol, and polyglycols based on ethylene glycol and/or propylene glycol. Corresponding monocarboxylic acids used as starting components preferably have 1 to 42, especially 4 to 18, preferably 8 to 14 carbon atoms and can be saturated or unsaturated, aliphatic or aromatic, linear, branched and/or cyclic. Examples of corresponding, suitable monocarboxylic acids are stearic acid, isostearic acid, oleic acid, lauric acid and benzoic acid. Additional suitable acids are the tertiary monocarboxylic acids, also known as Koch acids, such as 2,2-dimethylpentanoic acid, tert-nonanoic acid and neodecanoic acid.

In preferred embodiments, the dispersant composition the invention is a liquid at a temperature of 20° C. In order to render the composition liquid, the dispersant composition preferably comprises an organic solvent. Generally, an organic solvent is selected that is capable of dissolving the essential components of the dispersant composition, i.e. the at least one first polymer, the at least one amine, and the at least one second polymer. The organic solvent may also comprise more than one type of organic solvent, for example a mixture of two or more types of solvents. It is generally preferred that the solvent comprises an aprotic dipolar solvent, such as dimethyl sulfoxide, dimethyl formamide or N-methyl pyrrolidone, or other solvents comprising an amide group.

Generally, the organic solvent is present in the dispersant composition of the invention in an amount of 10 to 90% by weight, calculated on the total weight of the composition.

The dispersant composition of the invention is highly suitable as dispersing agent for a carbon-based material. Therefore, in some embodiments the composition of the invention comprises a carbon-based material. A carbon-based material is a material which consists for 90 to 100% by weight of carbon. For use in the field of electrode manufacture for batteries, a carbon-based material is selected which is electrically conductive. Examples of suitable electrically conductive carbon-based materials include carbon black, carbon nano tubes, graphite, carbon fibers, graphene, fullerenes, and mixtures thereof. Preferred carbon-based materials are carbon black, graphene, and carbon nano tubes. Specific types of suitable carbon black are furnace black and acetylene black.

In a further embodiment, the dispersant composition of the invention can used as dispersing agent carbon-coated non-conductive electrode material. An example of a non-conductive electrode material is LiFePO₄ and other cathode materials, which are used in lithium ion or lithium metal batteries for high power applications such as power tools, electric vehicles, and hybrid or plug-in hybrid electric vehicles. LiFePO₄ suffers from low intrinsic rate capability, which has been ascribed to the low electronic conductivity. One of the most promising approaches to overcome this problem is the addition of conductive carbon to the surface of LiFePO₄ particles.

The invention also relates to the use of the dispersant composition of the invention as a dispersing agent for an electrically conductive carbon-based material.

In a further embodiment, the invention relates process of preparing a dispersion of an electrically conductive carbon-based material comprising
i) Providing an electrically conductive carbon-based material,
ii) Providing the dispersant composition of the invention,
iii) Mixing the components provided on steps i) and ii) and exerting shear force to prepare a dispersion.

Shear force can be provided by well-known equipment for dispersing pigments, for example by ball mills or by high-speed stirrers.

Dispersions of carbon-based materials wherein the composition of the invention is used as dispersant exhibit favorable properties, such as low viscosity and small particle size of the carbon-based material.

The dispersant composition of the invention is very suitable to reduce the viscosity of a composition for preparing an electrode for a rechargeable battery. In particular, the dispersant composition can be added to a composition for preparing an electrode for a rechargeable battery, which causes a significant drop in the viscosity of the composition. This facilitates handling of the composition, without the need to add large amounts of viscosity reducing solvent.

Therefore, the invention also relates to the use of the dispersant composition of the invention for reducing the viscosity of a composition for preparing an electrode for a rechargeable battery.

The dispersant composition of the invention is highly suitable in preparing materials for preparing an electrode for a rechargeable battery.

Therefore, the invention also relates to a composition for preparing an electrode for a rechargeable battery comprising
i) a cathode active material
ii) an electrically conductive carbon-based material
iii) a polymeric binder which is different from the polymers comprised in the dispersant composition, and
iv) the dispersant composition of the invention.

The expression battery encompasses a single electrochemical cell that contains electrodes, a separator, and an electrolyte, as well as a collection of cells or cell assemblies.

The term cathode designates the electrode where reduction is taking place during the discharge cycle.

A transition metal oxide containing lithium, or a lithium metal phosphate, such as LiFePO₄, is generally used as a cathode active material, and preferably, an oxide mainly containing lithium and at least one kind of transition metal element selected from the group consisting of Ti, V, Cr, Mn, Fe, Co, Ni, Mo, and W, which is a compound having a molar ratio of lithium to a transition metal element of 0.3 to 2.2, is used. More preferably, an oxide mainly containing lithium and at least one kind of transition metal element selected from the group consisting of V, Cr, Mn, Fe, Co, and Ni, which is a compound having a molar ratio of lithium to a transition metal of 0.3 to 2.2, is used. It should be noted that Al, Ga, In, Ge, Sn, Pb, Sb, Bi, Si, P, B, and the like may be contained in a range of less than 30% by mole with respect to the mainly present transition metal. Of the above-mentioned active materials, it is preferred that at least one kind of material having a spinel structure represented by a general formula LiₓMO₂ (M represents at least one kind of Co, Ni, Fe, and Mn, and x is 0 to 1.2), or Li_{y}N₂O₄ (N contains at least Mn, and y is 0 to 2) be used.

Further, as the cathode active material, there may be particularly preferably used at least one kind of materials each including Li_{y}MₐD₁₋ₐO₂ (M represents at least one kind of Co, Ni, Fe, and Mn, D represents at least one kind of Co, Ni, Fe, Mn, Al, Zn, Cu, Mo, Ag, W, Ga, In, Sn, Pb, Sb, Sr, B, and P with the proviso that the element corresponding to M being excluded, y=0 to 1.2, and a=0.5 to 1) and materials each having a spinel structure represented by Liz (N_{b}E_{1-b})₂O₄(N represents Mn, E represents at least one kind of Co, Ni, Fe, Mn, Al, Zn, Cu, Mo, Ag, W, Ga, In, Sn, Pb, Sb, Sr, B and P, b=1 to 0.2, and z=0 to 2).

Specifically, there are exemplified LiₓCoO₂, LiₓNiO₂, LiₓMnO₂, LiₓCoₐNi₁₋ₐO₂, LiₓCO_{b}V_{1-b}O_{z}, LiₓCO_{b}Fe_{1-b}O₂, LiₓMn₂O₄, LiₓMn_{c}CO_{2-c}O₄, LiₓMn_{c}Ni_{2-c}O₄, LiₓMn_{c}V_{2-c}O₄, and LiₓMn_{c}Fe_{2-c}O₄ (where, x=0.02 to 1.2, a=0.1 to 0.9, b=0.8 to 0.98, c=1.6 to 1.96, and z=2.01 to 2.3). As the most preferred transition metal oxide containing lithium, there are given LiₓCoO₂, LiₓNiO₂, LiₓMnO₂, LiₓCoₐNi₁₋ₐO₂, LiₓMn₂O₄, and LiₓCO_{b}V_{1-b}O_{z} (x=0.02 to 1.2, a=0.1 to 0.9, b=0.9 to 0.98, and z=2.01 to 2.3). It should be noted that the value of x may increase and decrease in accordance with charge and discharge.

Although the average particle size of the cathode active material is not particularly limited, the size is preferably 0.1 to 50 μm. It is preferred that the volume of the particles of 0.5 to 30 μm be 95% or more. It is more preferred that the volume occupied by the particle group with a particle diameter of 3 μm or less be 18% or less of the total volume, and the volume occupied by the particle group of 15 μm or more and 25 μm or less be 18% or less of the total volume.

Although the specific area is not particularly limited, the area is preferably 0.01 to 50 m²/g, particularly preferably 0.2 m²/g to 1 m²/g by a BET method.

The electrically conductive carbon-based material in the composition for preparing an electrode suitably comprises at least one of carbon black, carbon nano tubes, graphite, carbon fibers, graphene, and fullerenes. Preferred carbon-based materials are carbon black, graphene, and carbon nano tubes.

The composition for preparing an electrode further comprises a polymeric binder which is different from the polymers comprised in the dispersant composition. Examples of the binder include known binders such as: fluorine-based polymers such as polyvinylidene fluoride and polytetrafluoroethylene; rubber-based binders such as styrene-butadiene rubber (SBR) or acrylonitrile-butadiene rubber (NBR), and binders based on polyacrylates or aqueous dispersions thereof.

The appropriate use amount of the binder is 1 to 50 parts by mass in terms of 100 parts by mass of the non-volatile material of the composition, and in particular, the used amount is preferably about 1.5 to 20 parts by mass.

The invention further relates to a process of preparing a rechargeable electrical battery electrode, wherein the composition for preparing an electrode for a rechargeable battery composition is used to prepare the battery electrode.

The composition is suitably used on the form of a paste. The paste for an electrode can be obtained by kneading the components of the composition. A known device such as a ribbon mixer, a screw-type kneader, a Spartan Granulator, a Loedige Mixer, a planetary mixer, or a universal mixer may be used for kneading. The paste for an electrode may be formed into a sheet shape, a pellet shape, or the like.

A solvent can be used at the time of kneading. Examples of the solvent include known solvents such as dimethylformamide and isopropanol; toluene and N-methylpyrrolidone in the case of a fluorine-based polymer; water in the case of SBR. In the case of the binder using water as a solvent, it is preferred to use a thickener together. The amount of the solvent is adjusted so as to obtain a viscosity at which a paste can be applied to a collector easily.

An electrode may be formed of a molding of the above-mentioned paste for an electrode. The electrode is obtained, for example, by applying the paste for an electrode to a collector, followed by drying and pressure molding.

Examples of the collector include foils and mesh of aluminum, nickel, copper, stainless steel and the like. The coating thickness of the paste is generally 40 to 200 μm. There is no particular limitation to the paste coating method, and an example of the coating method includes a method involving coating with a doctor blade or a bar coater, followed by molding with roll pressing or the like.

Examples of the pressure molding include roll pressure molding, compression molding, and the like. The pressure for the pressure molding is preferably about 1 to 3 t/cm². As the density of the electrode increases, the battery capacity per volume generally increases. However, if the electrode density is increased too much, the cycle characteristic is generally degraded. If the paste for an electrode in a preferred embodiment of the present invention is used, the degradation in the cycle characteristic is small even when the electrode density is increased. Generally, the electrode density is in the range of 1.0 to 4.0 g/cm³. In some embodiments, the electrode density of a cathode is in the range of 2.0 to 3.5 g/cm³, and the density of an anode is in the range of 1.2 to 2.0 g/cm³.

### EXAMPLES

Potassium carbonate: (Sigma-Aldrich)
(Dowanol) PMA: 1-methoxy-2-propyl acetate (DOW Chemicals)
SMA 2000: Styrene-maleic anhydride copolymer (molar ratio of styrene/maleic anhydride=2/1) (Polyscope)
Jeffamine M 2070: Amine-terminated EO/PO polyether (Huntsman)
Lutensol AO11: Fatty alcohol (number of carbon: 13-15) ethoxylate (repeating unit of polyethylene glycol=11) (BASF)
DMAPA: N,N-Dimethylaminopropylamine (Huntsman)
Grilonit RV 1814: Alkyl (number of carbon: 13-15) glycidyl ether (EMS-GRILTECH)
Benzoic acid: (Sigma-Aldrich)
AMP: 95% of 2-amino-2-methyl-1-propanol and 5% of water,
(Sigma-Aldrich)
NMP: N-Methylpyrrolidone (BASF)
Tetraisopropyl orthotitanate: (Thermo Fisher)
Benzenesulfonic acid, dodecyl-: (Akzo Nobel)
ε-Caprolactone: (BASF)
Lauric acid: (Merck KGaA)
Zirconium (IV) butoxide solution: (ABCR)
Polyimine 2000:1,2-Ethanediamine, polymer with aziridine (BASF)
Cardura E10: Neodecanoic acid, oxiranylmethyl ester (Hexion)
MPEG 350: Poly(oxy-1,2-ethanediyl), a-methyl-w-hydroxy-(Clariant)
δ-Valerolactone: (BASF)
Ethanol, 2-(dibutylamino)-: (BASF)
Breox B 35: Poly[oxy(methyl-1,2-ethanediyl)], a-butyl-w-hydroxy-(BASF)
Desmodur N 3400: Hexane, 1,6-diisocyanato-, homopolymer (Covestro)
DBTL: Dibutyl tin dilaurate (Sigma Aldrich)
Epomin SP-003:1,2-Ethanediamine, N₁-(2-aminoethyl)-, polymer with aziridine
(Sumitomo)
Propenoic acid, 2-ethylhexyl ester: (Novasol)

### Measurement of Non-Volatile Content (Solids Content)

The sample (2.0±0.2 g of the tested substance) was weighed accurately into a previously dried aluminum dish and dried for 20 minutes at 150° C. in the varnish drying cabinet, cooled in a desiccator and then reweighed. The residue corresponds to the solids content in the sample (ISO 3251).

### Measurement of the Amine Value

1.5 to 3.0 g of a dispersant was precisely weighed out into a 80 ml beaker and dissolved with 50 mL of acetic acid. Using an automatic titration device provided with a pH electrode, this solution was neutralization-titrated with a 0.1 mol/L HClO₄ acetic acid solution. A flexion point of a titration pH curve was used as a titration endpoint, and an amine value was obtained by the following equation (DIN 16945).

$$Amine value [ mg KOH / g ] = ( 561 \times 0.1 \times f \times V ) / ( W \times S )$$

(wherein f: factor of titration agent, V: titration amount at titration endpoint [mL], W: weighed amount of dispersant sample [g], S: solid matter concentration of dispersant sample [wt %])

### Measurement of the Acid Value

1.5 to 3.0 g of a dispersant was precisely weighed out into a 80 ml beaker and dissolved with 50 mL of ethanol. Using an automatic titration device provided with a pH electrode, this solution was neutralization-titrated with a 0.1 mol/L ethanolic KOH solution. A flexion point of a titration pH curve was used as a titration endpoint, and an amine value was obtained by the following equation (DIN EN ISO 2114).

$$Acid value [ mg KOH / g ] = ( 561 \times 0.1 \times f \times V ) / ( W \times S )$$

(wherein f: factor of titration agent, V: titration amount at titration endpoint [mL], W: weighed amount of dispersant sample [g], S: solid matter concentration of dispersant sample [wt %])

### Gel Permeation Chromatography (GPC)

Weight-average molecular weight Mw was determined according to DIN 55672-1:2007-08 at 40° C. using a high-pressure liquid chromatography pump (WATERS 600 HPLC pump) and a refractive index detector (Waters 410). As separating columns, a combination was used of 3 Styragel columns from WATERS with a size of 300 mm×7.8 mm ID/column, a particle size of 5 μm, and pore sizes HR4, HR2 and HR1. The eluent used was tetrahydrofuran with 1% by volume of dibutylamine, with an elution rate of 1 ml/min. The conventional calibration was carried out using polystyrene standards.

### Synthesis of Comb Copolymer C-1

85 g PMA was added into a reactor. 21 g SMA 2000 was added during stirring, while the mixture was heated up to 70° C. Then, 64 g of Jeffamine M 2070 and 4 g of DMAPA were added dropwise to the reactor. The reaction was carried at 170° C. for 4 hours. PMA was distilled off during the reaction. Mw of the polymer was 30210 g/mol.

In a next step, the reactor was cooled down to 120° C. Then, 9 g of Grilonit RV 1814 and 4 g of benzoic acid were added to the reactor. The reaction was carried out at 120° C. for 4 hours. After that, a comb copolymer C-1 was obtained.

The comb copolymer C-1 has a 100% solid content, an amine value of 18 mg KOH/g and an acid value of 8 mg KOH/g.

### Synthesis of Comb Copolymer C-2

85 g PMA was added into a reactor. 21 g SMA 2000 was added during stirring, while the mixture was heated up to 70° C. After addition of 0.4 g potassium carbonate, 43 g Lutensol AO11 was added dropwise and the reactor was heated up to 140° C. for 4 hours.

In a next step, PMA was distilled off at 150° C. at reduced pressure. After cooling down to 80° C., 30 g NMP was added to the reactor. After adding 6 g AMP, followed by homogenization, comb copolymer C-3 was obtained.

The comb copolymer C-3 has a 70% theoretical solid content (solvent: NMP), an amine value of 37 mg KOH/g and an acid value of 27 mg KOH/g. Mw of the comb copolymer C-3 was 9600 g/mol.

### Synthesis of Comb Copolymer C-3

The polyacrylate to be used for aminolysis was prepared by the generally known processes, such as by free-radical polymerization. More specialized production processes, such as anionic polymerization or group transfer polymerization are also possible.

1450 g of a poly-n-butyl acrylate (Mw about 12.000) were mixed with 177 g of DMAPA. Furthermore, 0.5 g of benzenesulfonic acid, dodecyl—was added as catalyst. The reaction mixture was heated to reflux (approx. 180° C.) under nitrogen. Due to the n-butanol released during the reaction, the boiling point dropped to approx. 130° C. After about 15-17 h, the reaction was completed and the released n-butanol was distilled off. Concurrently, 35.32 g of MPEG 350 was added. The reaction mixture was heated to 100° C. under nitrogen. Now 0.33 g of tetraisopropyl orthotitanate was added and stirred for 2 h at 200° C. Then another 0.33 g of tetraisopropyl orthotitanate was added and stirred for another 2 h at 200° C. The released n-butanol was distilled off. Then 0.17 g of tetraisopropyl orthotitanate was added and stirred for 1 h at 200° C. The released n-butanol was distilled off.

The comb copolymer C-3 has a 100% solid content and an amine value of 32 mg KOH/g. Mw of the comb copolymer C-3 was 17000 g/mol.

### Synthesis of Branched Polymer C-4

25.6 g of lauric acid and 160.3 g of s-caprolactone were mixed and heated to 100° C. with stirring under nitrogen. Then 0.1 g of zirconium (IV) butoxide solution was added and further heated to 190° C. under nitrogen. Stirring was continued at this temperature until a solid content of >99% was reached. The reaction temperature was reduced to 100° C. 11.6 g of Polyimin 2000 and 2.4 g of Cardura E10 were added. The reaction mixture was heated to 140° C. for 5 h. After cooling the branched polymer C-4 was obtained.

The branched polymer C-4 has 100% solid content. The amine value was 39 mg KOH/g and the acid value was 5 mg KOH/g. Mw of the branched polymer was 16000 g/mol.

### Synthesis of Branched Polymer C-5

13.21 g of MPEG 350, 8.30 g of s-caprolactone and 4.87 g of 8-valerolactone were mixed and heated to 160° C. with stirring under nitrogen. 0.04 g of benzenesulfonic acid, dodecyl—was added and further heated to 160° C. under nitrogen. Then 0.02 g of ethanol, 2-(dibutylamino)—was added and stirring was continued until a solid content of >97% was reached. The obtained monofunctional polyester was cooled to room temperature.

105.69 g of Breox B 35 and 43.26 g of Desmodur N 3400 were combined with the above obtained monofunctional polyester. The mixture was heated to 80° C. and 0.01 g DBTL was added. The reaction mixture was stirred until the NCO content was below 0.1%. Then 5.44 g of ethanol, 2-phenoxy—was added and the mixture was homogenized. 11.26 g of Epomin SP-003 was added and the mixture was stirred until the amine value was at 63% of the initial value. 7.93 g of 2-propenoic acid, 2-ethylhexyl ester was added and the mixture was stirred for 1 h. After cooling the branched polymer C-5 was obtained.

The branched polymer C-5 has 100% solid content. The amine value was 47 mg KOH/g and the hydroxy value was 34 mg KOH/g.

### Preparation of Dispersant Compositions and Comparative Dispersant Compositions

A polymer (C-1 to C-5), AMP or ethanolamine (EA) and hydroxypropyl methylcellulose HPMC) or ethyl cellulose (EC) stored in a sealed box were dissolved in NMP in a 140 ml glass bottle. Then, Carbon nano tubes (CNT, FT 7320 produced by CNANO) was added with 150 g of 2 mm Zirconia beads. The dispersions were prepared using a paint shaker Disperser DAS 200 (LAU GmbH). Dispersing time was 12 hours at 30° C. to obtain the respective CNT dispersion D-1 to D-11 (Details are described in Table 1).

TABLE 1

| | | | | | | | | Weight ratios | |
|---|---|---|---|---|---|---|---|---|---|
| | | | | | | | | between a | |
| | | Dispersant | | | | | | polymer, | |
| Name | | Polymer | | | | | | modified | Solvent |
| of CNT | CNT | Product | Amount | HPMC | EC | AMP | EA | cellulose and | NMP |
| dispersion | (g) | name | (g) | (g) | (g) | (g) | (g) | Amine | (g) |
| D-1 | 2.00 | C-1 | 0.10 | 0.45 | | 0.45 | | 10/45/45 | 47.00 |
| D-2 | 2.00 | C-2 | 0.14 | 0.45 | | 0.45 | | 10/45/45 | 46.96 |
| D-3 | 2.00 | C-3 | 0.10 | 0.45 | | 0.45 | | 10/45/45 | 47.00 |
| D-4 | 2.00 | C-4 | 0.10 | 0.45 | | 0.45 | | 10/45/45 | 47.00 |
| D-5 | 2.00 | C-2 | 0.14 | 0.45 | | | 0.45 | 10/45/45 | 46.96 |
| D-6 | 2.00 | C-5 | 0.10 | 0.70 | | 0.20 | | 10/70/20 | 47.00 |
| D-7* | 2.00 | C-2 | 0.68 | 0.48 | | 0.05 | | 47.6/47.6/4.8 | 46.80 |
| D-8* | 2.00 | C-5 | 0.48 | 0.48 | | 0.05 | | 47.6/47.6/4.8 | 47.00 |
| D-9* | 2.00 | C-5 | 0.48 | | 0.48 | 0.05 | | 47.6/47.6/4.8 | 47.00 |
| D-10 | 2.00 | C-5 | 0.10 | | 0.45 | 0.45 | | 10/45/45 | 47.00 |
| D-11 | 2.00 | C-5 | 0.10 | | 0.70 | 0.20 | | 10/70/20 | 47.00 |

Comparative Examples are marked by *

### Preparation of Compositions for Preparing an Electrode for a Rechargeable Battery and Comparative Compositions

The electrode material Li₁₊ₓ(Ni_{0.5}Co_{0.2}Mn_{0.3})₁₋ₓO₂(NCM), polyvinylidene difluoride (PVdF) as a binding agent, and a CNT dispersion as a conductive auxiliary agent were added to N-methyl-2-pyrrolidone. The mass ratio, based on non-volatile material, in a paste of electrode material was NCM: CNT: PVdF=97.5:0.5:2, and the components were mixed together, thereby preparing the paste of an electrode material.

The paste of an electrode material was applied to a surface of 180 μm-thick polyethylene terephthalate (PET) sheet so as to form a coating, and the coating was dried, thereby forming a cathode layer on the surface of the PET sheet. After that, this PET sheet with cathode layer was cut to 3 cm width to measure the volume resistivity of the cathode layer. The viscosity of CNT dispersion was measured by using BROOKFIELD VISCOMETER DV-Il+, and the volume resistivity of the electrode coating was measured by means of a four point measurement using a low resistivity meter (Mitsubishi Chemical Corporation product, model No.: Loresta-AX) at 25° C. These were described in Table 2.

TABLE 2

| | CNT paste viscosity at 6 rpm (mPa S) | | | |
|---|---|---|---|---|
| Name of | | stored at room | | VR of |
| CNT | | temperature | change | cathode |
| dispersion | Initial | for 12 days | ratio | (Ω cm) |
| D-1 | 340 | 344 | 1% | 23.2 |
| D-2 | 440 | 410 | −7% | 20.1 |
| D-3 | 401 | 353 | −12% | 20.2 |
| D-4 | 275 | 331 | 20% | 19.2 |
| D-5 | 567 | 471 | −17% | 20.5 |
| D-6 | 249 | 283 | 14% | 23.8 |
| D-7* | 1051 | 2468 | 135% | 22.6 |
| D-8* | 161 | 406 | 152% | 19.3 |
| D-9* | 266 | 471 | 77% | 26.8 |
| D-10 | 270 | 358 | 33% | 17.5 |
| D-11 | 406 | 427 | 5% | 20.5 |

Comparative Examples are marked by *

From Table 2 it can be inferred that the carbon nanotube dispersions prepared with dispersant compositions according to the invention exhibit a significantly lower change of viscosity upon storage than the dispersions prepared with comparative dispersant compositions. The volume resistivity is on an acceptable level in all cases.

1. A dispersant composition comprising
a) 30 to 80% by weight of at least one first polymer
b) 10 to 60% by weight of at least one amine having a molecular weight of at most 250 g/mol, and
c) 5 to 20% by weight of at least one second polymer, which is different from the first polymer,
wherein the % by weight are calculated on the total weight of a), b), and c).

2. The composition according to claim 1, wherein the composition comprises
a) 40 to 75% by weight of the at least one first polymer,
b) 15 to 55% by weight of the at least one amine having a molecular weight of at most 250 g/mol, and
c) 7 to 15% by weight of the at least one second polymer, which is different from the first polymer.

3. The composition according to claim 1- or 2, wherein the at least one first polymer is selected from linear polymers having a linear polymer chain without polymeric side chains or polymeric branches.

4. The composition according to claim 3, wherein the at least one first polymer is selected from polyvinylpyrrolidone, modified cellulose, or mixtures thereof.

5. The composition according to claim 4, wherein the modified cellulose comprises hydroxymethylpropyl cellulose.

6. The composition according to claim 1, wherein the at least one amine having a molecular weight of at most 250 g/mol has one amine group and one hydroxyl group.

7. The composition according to claim 1, wherein the at least one second polymer is selected from comb polymers, branched polymers, hyperbranched polymers, and mixtures thereof.

8. The composition according to claim 7, wherein the at least one second polymer comprises a comb polymer having a polymer backbone comprising polymerized units of styrene and maleic anhydride, and lateral side chains comprising ether groups.

9. The composition according to claim 8, wherein the at least one second polymer further comprises neutralized carboxylic acid groups.

10. The composition according to claim 1, wherein the composition further comprises at least one organic solvent in an amount of 10 to 90% by weight, calculated on the total weight of the composition.

11. The composition according to claim 10, wherein the at least one organic solvent comprises an amide group.

12. The composition according to claim 1, wherein the composition further comprises an electrically conductive carbon-based material.

13. The composition according to claim 12, wherein the electrically conductive carbon-based material comprises at least one of carbon black, carbon nano tubes, graphite, carbon fibers, graphene, and fullerenes.

14. (canceled)

15. (canceled)

16. A composition for preparing an electrode for a rechargeable battery comprising
i) a cathode active material
ii) an electrically conductive carbon-based material
iii) a polymeric binder which is different from the polymers comprised in the composition according to claim 1, and
iv) the composition according to claim 1.

17. A process of preparing a dispersion of an electrically conductive carbon-based material comprising
i) Providing an electrically conductive carbon-based material,
ii) Providing a composition according to claim 1,
iii) Mixing the components provided on steps i) and ii) and exerting shear force to prepare a dispersion.

18. A process of preparing a rechargeable electrical battery electrode, wherein the composition according to claim 12 is used to prepare the battery electrode.
